(19) United States
(12) Patent Application Publication
(10) Pub. No.: US 2024/0102606 A1
(43) Pub. Date: Mar. 28, 2024

(54) Height Adjustable Support Structure

(71) Applicant: Grant Follis, Altadena, CA (US)

(72) Inventor: Grant Follis, Altadena, CA (US)

(21) Appl. No.: 17/950,099

(22) Filed: Sep. 22, 2022

(51) Int. Cl. F16M 11/28; F16M 11/04

(52) U.S. Cl. CPC F16M 11/28; F16M 11/04

(57) ABSTRACT

A height adjustable support structure (HASS) that allows a person to mount a device/item such as a smoke/CO₂ detector or camera to a surface-attached or free-standing structure. The surface attached configuration of the HASS is designed to be attached onto a surface such as a wall or a door, or a convex or rounded (tube-like) surface and is comprised of a rod mounting bracket having a spacing member, a rod support member that is integrally attached to the front surface of the spacing member, a hollow rod that is configured to fit within the rod support member, a rod insert that is configured to fit within the hollow rod, and a device mounting bracket that fits on and around the hollow rod. The free-standing configuration of the HASS is similar to the surface attached configuration except the free-standing does not have a rod mounting bracket with a spacing member. The free-standing HASS does add a base with an insert that extends upward from the substantial center of the base. The base insert is dimensioned to fit into, up to an effective distance, the lower end of the hollow rod, thereby supporting and maintaining the rod and the other components in an upward vertical position.

### TECHNICAL FIELD

The invention generally pertains to devices for supporting or securing an item to a surface, and more particularly to a height adjustable support structure that allows a variety of items/devices such as a smoke or CO₂ detector or a camera, to be mounted to surface, or be free standing, and at a location/height that can be selected by a user.

### BACKGROUND ART

In a typical household there are many products/items that are used to provide safety or simply to add convenience to daily living. A couple examples of these are fire/CO₂ detectors or alarms, and home security devices such as a camera. One common issue with many of these is that they must be mounted or placed at an elevated location that facilitates their use. Often these products/items are mounted or secured to a surface such as a wall. To accomplish this some type of bracket is usually used. A problem exists though that to access a product/item the bracket mounting is normally permanent and once mounted, a product/item cannot be accessed.

For some people, especially those with limited/compromised mobility or small stature, this bracket moving can be problematic because many products/items require periodic access e.g., to replace a depleted battery or even to clean. When a product/item is mounted near a ceiling, a ladder or stool must be used, or when a product/item is mounted near a floor, a person must be ale to bend down to the low location. The difficulty in accessing products/items can be a serious inconvenience or even a safety risk, especially for products/items placed near high ceilings.

There have been attempts to provide a solution to this problem. Many products/items claim to be quickly and easily removable which does not help with the actual accessing the product/item, or a product/item can be hardwired into a home or office electrical system or hardwired with a back-up battery which needs to be replaced. While hardwiring does remove the need to replace a battery, a hardwired product/item is effectively permanently attached at a certain location. Also hardwiring requires an electrician or a person with electrical skills to attach a new product/item or to provide service on a product/item not functioning correctly.

It is obvious that there is a need for some type of device or apparatus that would allow a product/item to be mounted/attached at a desired location and also allow actual quick and easy access to the product/item for all people, even those who experience difficulty in accomplishing such tasks. This could be realized by providing a means by which a product/item could be securely mounted at a desired location (or height) while allowing the product/item to moved up or down (or even sideways if desired). Another version would allow a product/item to be placed at a desired location or height while remaining free-standing and not mounted/attached to a surface. A free-standing version could be adjusted for height and could also be placed at a selected location within a room, or even moved from one room to another. Products/items that require power from a mains utility power could be placed near a wall outlet, and battery-powered products/items could be placed almost anywhere, indoors or outdoors.

A search of the prior art did not disclose any literature or patents that read directly on the claims of the instant invention. However, the following U.S. patents are considered related:

| PATENT NO. | INVENTOR | ISSUED |
|---|---|---|
| 8,404,971 | Gretz | Mar. 26, 2013 |
| 10,883,656 | Follis | Jan. 5, 2021 |
| 11,058,022 | Ross | Jul. 6, 2021 |

The U.S. Pat. No. 8,404,971 discloses an assembly for mounting a security camera, detector, or electrical fixture to an indoor or outdoor surface. The mounting assembly includes an electrical box for use with mounting adapters. A ceiling mounting adapter enables mounting the electrical box to the ceiling or to a down rod secured to the ceiling. A wall mounting adapter enables mounting the electrical box to a wall. A corner mounting adapter enables mounting the electrical box to a corner. The mounting adapters can accept fasteners for securing a camera or fixture.

The U.S. Pat. No. 10,883,656 discloses an apparatus to enable people who are handicapped, especially wheelchair bound, to be able to install and replace objects that are affixed near a ceiling. The apparatus includes a lower level affixed at a location within reach of a seated person and including a vertical height adjustable pole movably retained by a plate at the lower level. A top plate is affixed adjacent a top end of a vertical height adjustment pole which is lowered to be in reach of the seated person. After access to a device is completed, the adjustment pole is retained so that the top plate is adjacent a ceiling.

The U.S. Pat. No. 11,058,022 discloses a vertical track and sliding mount for a smoke detector that comprises a guide tube, lifting tube, and amounting base. The mounting base may couple to a detector and be coupled to the top end of the lifting tube. The detector is raised and lowered by sliding the lifting tube vertically within the guide tube. A height lock may hold the lifting tube at an elevated or lowered position.

For background purposes and indicative of the art to which the invention relates, reference may be made to the following remaining patents found in the patent search.

| PATENT NO. | INVENTOR | ISSUED |
|---|---|---|
| 5,149,038 | VanCleve | Sept. 22, 1992 |
| 5,563,766 | Long, et al | Oct. 8, 1996 |
| 7,063,296 | Williams | Jun. 20, 2006 |
| 7,233,254 | Howell | Jun. 19, 2007 |
| 8,038,112 | Kluge | Oct. 18, 2011 |
| 8,148,635 | Gretz | Apr. 3, 2013 |

### DISCLOSURE OF THE INVENTION

A height adjustable support structure (HASS) that allows a person to mount a device/item such as a smoke/CO₂ detector or camera to a surface-attached or free-standing structure. The surface attached configuration of the HASS is designed to be attached onto a surface such as a wall or a door, or a convex or rounded (tube-like) surface and is comprised of a rod mounted bracket having a spacing member, a rod support member that is integrally attached to the front surface of the spacing member, a hollow rod that is configured to fit within the rod support member, a rod insert that is configured to fit within the hollow rod, and a device mounting bracket that fits on and around the hollow rod.

The free-standing configuration of the HASS is similar to the surface attached configuration except the free-standing does not have a rod mounting bracket with a spacing member. The free-standing HASS does add a base with an insert that extends upward from the substantial center of the base. The base insert is dimensioned to fit into, up to an effective distance, the lower end of the hollow rod, thereby supporting and maintaining the rod and the other components in an upward vertical position.

An optional wrench holder is utilized to hold a wrench that is sized to fit screws, such as a set screw, that are inserted into and tightened within bores on the HASS. Also, the HASS can include at least two pressure ball latch and cavity combinations. The pressure ball latch is dimensioned to fit within the cavity to maintain the mounting bracket and any attached device/item at a specific location on the HASS. When two pressure ball latches and cavities are used, they are preferably placed near the upper end and the lower end of the HASS. When more than two pressure ball latches and cavities are used, they can be at any desired/required location and be equally-spaced apart or non-equally spaced. Removing a bracket with a device/item from a pressure ball latch and cavity is not difficult as only a small amount of force is required to dislodge the pressure ball latch from the cavity.

In order to facilitate the attachment of a variety of items such as different smoke/CO₂ detectors or cameras, various devices can be secured to the bracket, and then an item can be secured to the device which can include an electrical box, a metal bracket for securing magnetic items, a shelf or other designs. When an item that uses/has a cable such as a power cable or a data cable, there are slots extending the length of the rod to allow the cable to easily fit within the HASS and allow the cable to be accessed.

In view of the above disclosure, the primary object of the invention is to provide a height adjustable support structure that allows a person to mount a variety of devices/items in either a surface-attached or free-standing configuration.

In addition to the primary object of the invention, it is also an object of the invention to provide a height adjustable support structure that:
a is easy to use,
can be sold assembled or be sold as a kit that is assembled by an end user,
has a surface-attached design that can be attached to a variety of surfaces such as a wall or door, or a convex/rounded (or tube-like)
has a free-standing design that can easily be moved from one location to another,
can be used indoors or outdoors,
does not interfere with the operation or function of any mounted device/item,
a allows much easier access to a device/item that requires maintenance or service,
can be installed as a built-in element of a home or office,
can support multiple devices/items on a single structure, and
is cost effective from both manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic view of a height adjustable support structure (HASS) in a fixed surface mounted configuration.

FIG. 2 is an orthographic view of the HASS in the fixed surface mounted configuration with examples of three devices including an electrical box, a metal bracket for magnetic devices or a shelf, that could be secured on the HASS.

FIG. 3 is an orthographic view of the HASS n a free-standing configuration.

FIG. 4 is an orthographic view of the HASS in the free-standing configuration with examples of three devices including an electrical box, a metal bracket for magnetic devices or a shelf that could be secured to the HASS.

FIG. 5 is an orthographic front view of the HASS surface mounted configuration rod mounting bracket.

FIG. 6 is an orthographic rear view of the HASS surface mounted configuration rod mounting bracket.

FIG. 7 is an orthographic front view of the HASS rod.

FIG. 8 is an orthographic rear view of the HASS rod.

FIG. 9 is a detail of a section of the HASS rod showing a wrench holder.

FIG. 10 is an orthographic front view of the HASS free-standing configuration rod support member.

FIG. 11 is an orthographic rear view of the HASS free-standing configuration rod support member.

FIG. 12 is an orthographic front view of the HASS rod insert.

FIG. 13 is an orthographic rear view of the HASS rod insert.

FIG. 14 is an orthographic front view of the HASS device mounting bracket.

FIG. 15 is an orthographic rear view of the IASS device mounting bracket.

FIG. 16 is an elevational view showing both the surface mounted configuration and free-standing configuration of the HASS.

FIG. 17 is a top plan view of the HASS surface mounted configuration.

FIG. 18 is an elevational view of the HASS surface mounted configuration.

FIG. 19 is a top plan view of the HASs free-standing configuration.

FIG. 20 is an elevational view the HASS free-standing configuration.

### BEST MODE FOR CARRYING OUT THE INVENTION

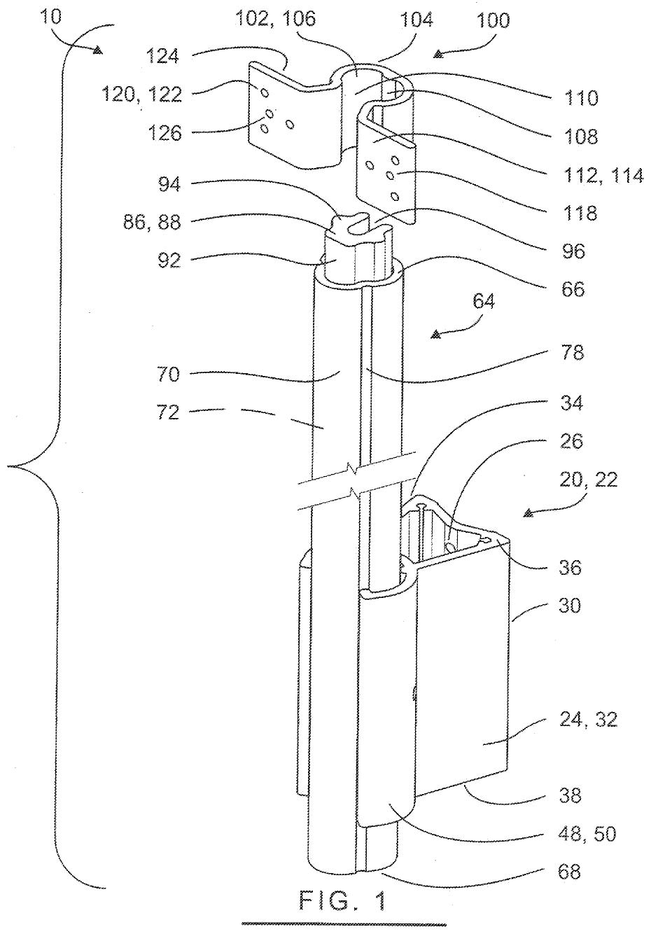

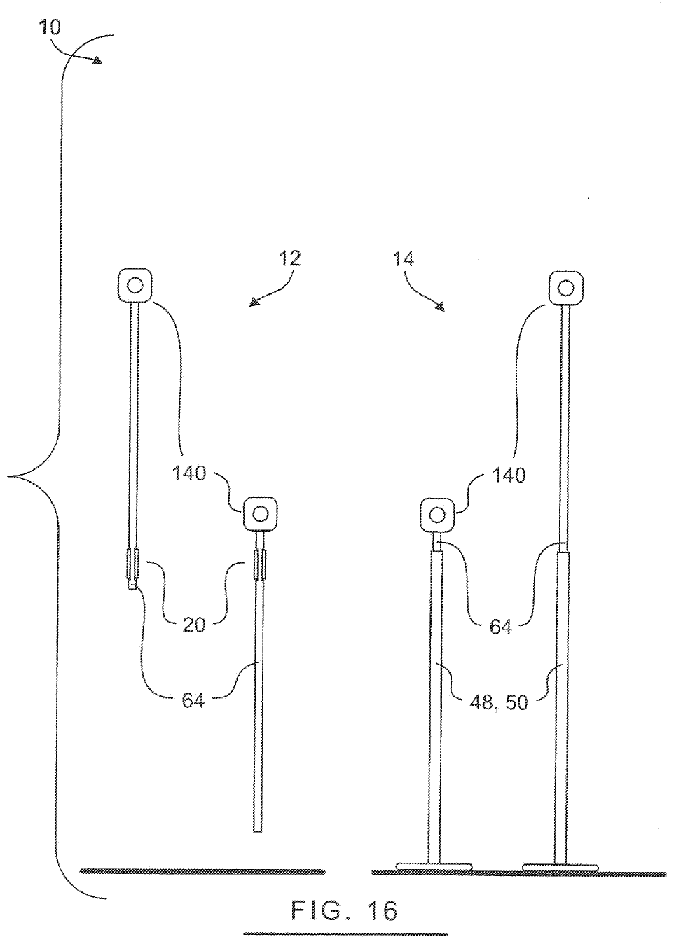

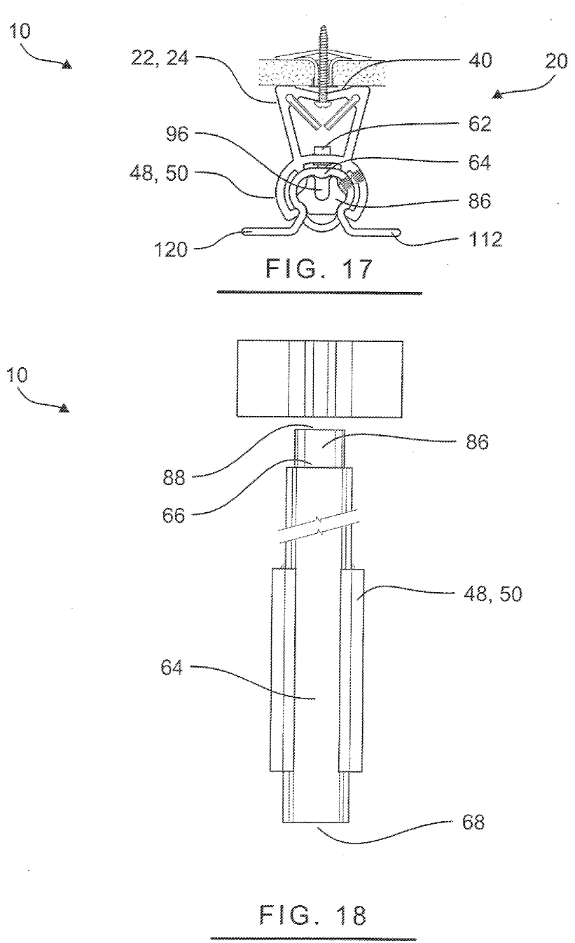

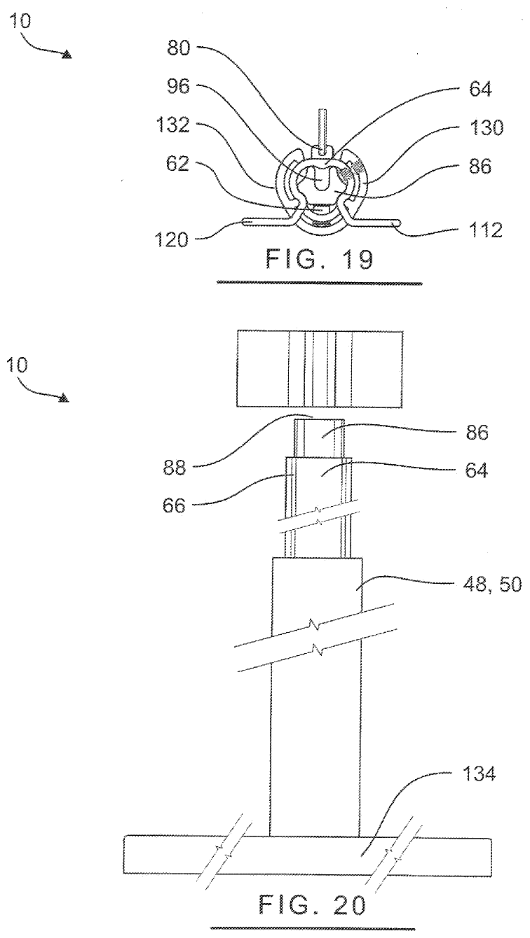

The best mode for carrying out the invention is presented in terms that disclose a preferred embodiment with two design configurations of a height adjustable support structure (HASS). In many locations, especially a home or office, there is a need or requirement to mount items/devices on a surface, or to have certain items/devices within a home or office, placed at a useful location/height. The HASS 10, as shown in FIGS. 1-20, provides a person with the ability to mount an item/device, such as a smoke/CO₂ detector or a camera, at an optimal location/height while still providing quick and easy access to the mounted item/device.

The first design configuration 12 of the HASS 10, as shown in FIGS. 1, 2 and 16-18, is intended to be used while fixedly attached to a surface such as a wall or a door, or to a convex or rounded (tube-like) surface. The first design is comprised of the following major elements: a rod mounting bracket 20, a rod support member 48, a hollow rod 64, a rod insert 86, and a device mounting bracket 100.

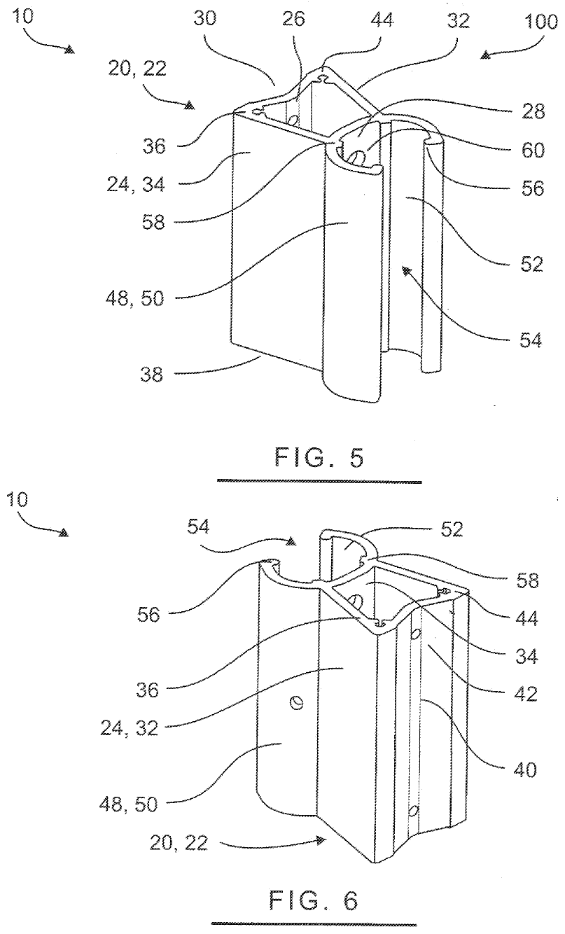

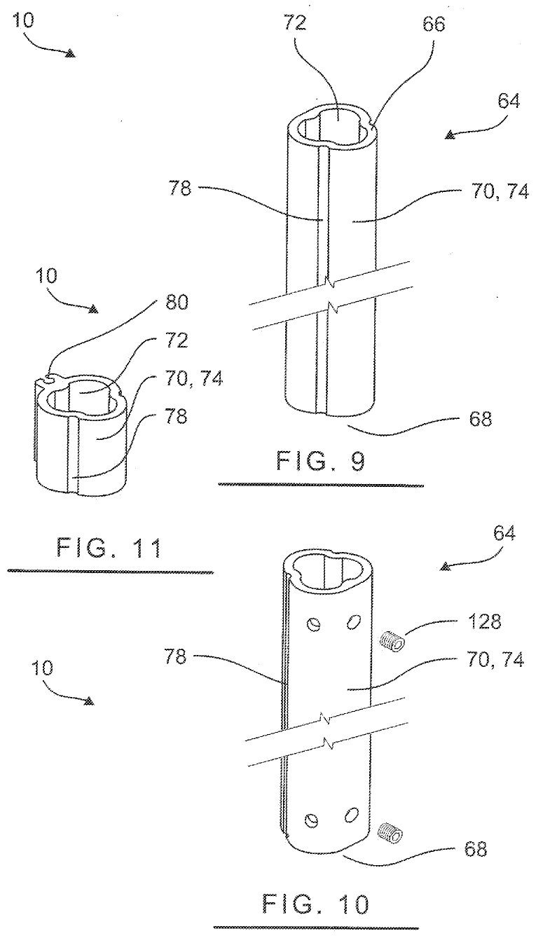

The rod mounting bracket 20, as shown in FIGS. 5 and 6, is comprised of a spacing member 22 with an outer surface 24, an inner surface 26, a front surface 28, a rear surface 30, a first side surface 32, a second side surface 34, an upper perimeter edge 36, a lower perimeter edge 38, a depressed section 40 located on the rear surface 30, and at least one bracket bore 42. Optionally, the spacing member 22 can also have a wrench holder 44, as shown in FIG. 9, that maintains a wrench that is sized to fit screws which are inserted into and tightened on the HASS 10.

As shown in FIGS. 10 and 11, the rod support member 48 has an outer surface 50, an inner surface 52, and open channel 54 that functions as a wire slot, an internal front rod guide 56, an internal rear rod guide 58 and at least one bore 60.

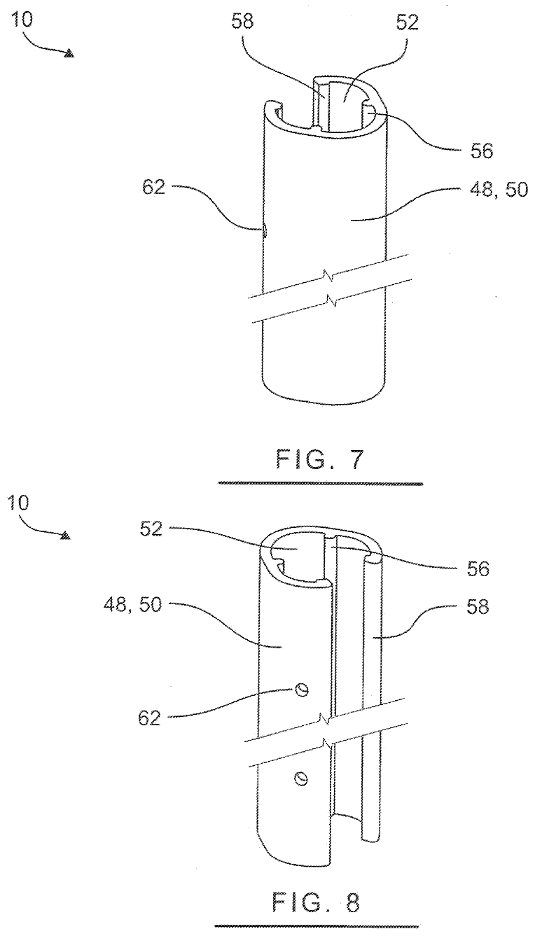

The hollow rod 64, as shown in FIGS. 7 and 8, is configured to fit within the rod support member 48 and has an upper end 66, a lower end 68, an outer surface 70, an inner surface 72, a semi-circular side section 74, a rod slot 76, a vertical channel 78, and at least one bore 82.

As with the spacing member, there can also be a wrench holder 89 adjacent the rod slot 76.

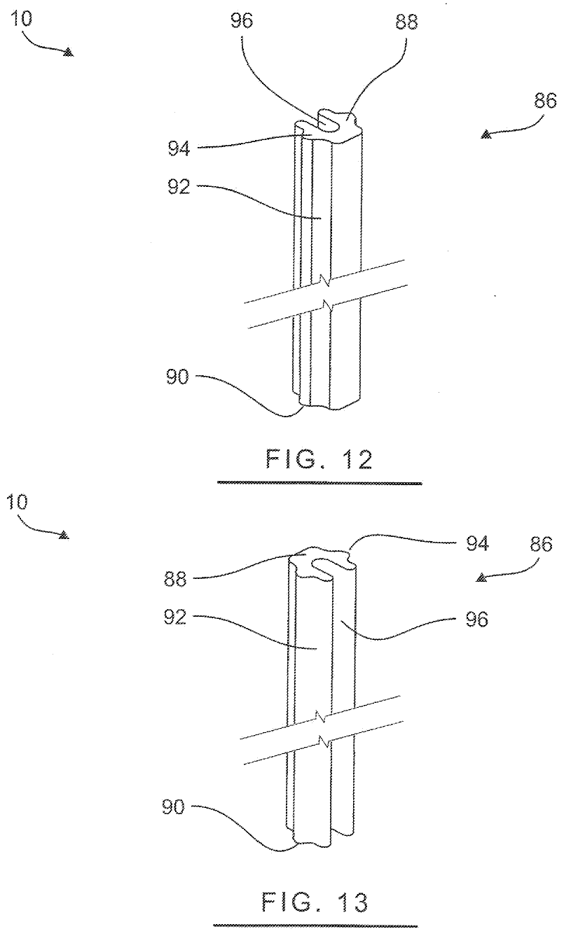

As shown in FIGS. 12 and 13, configured to fit within the hollow rod 64, is a rod insert 86 that comprises an upper end 88, a lower end 90, an outer surface 92, multiple semi-circular flanges 94, and a cable channel 96.

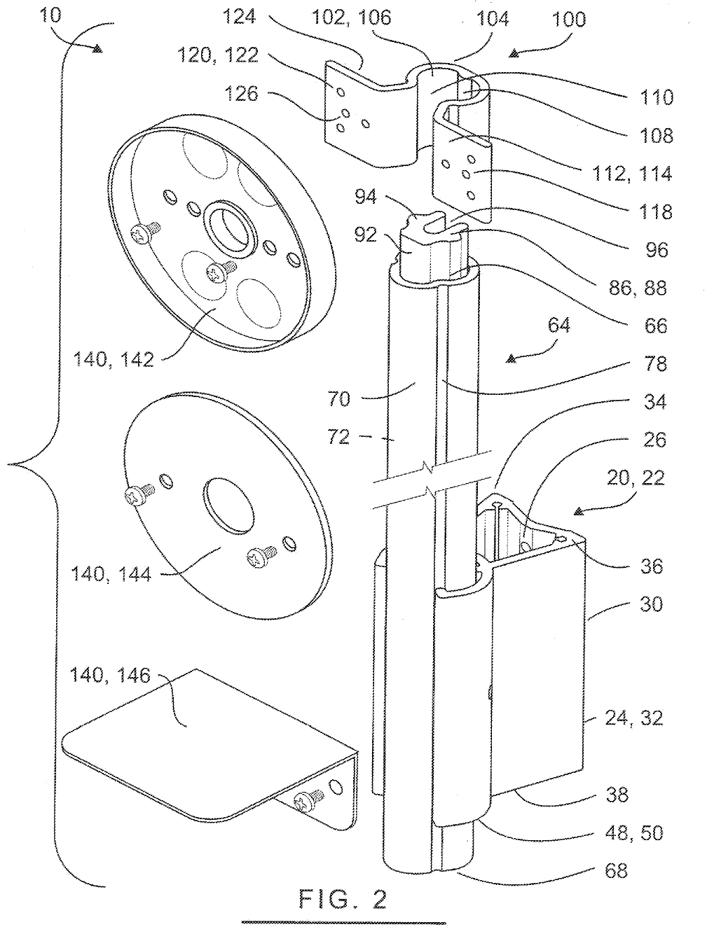

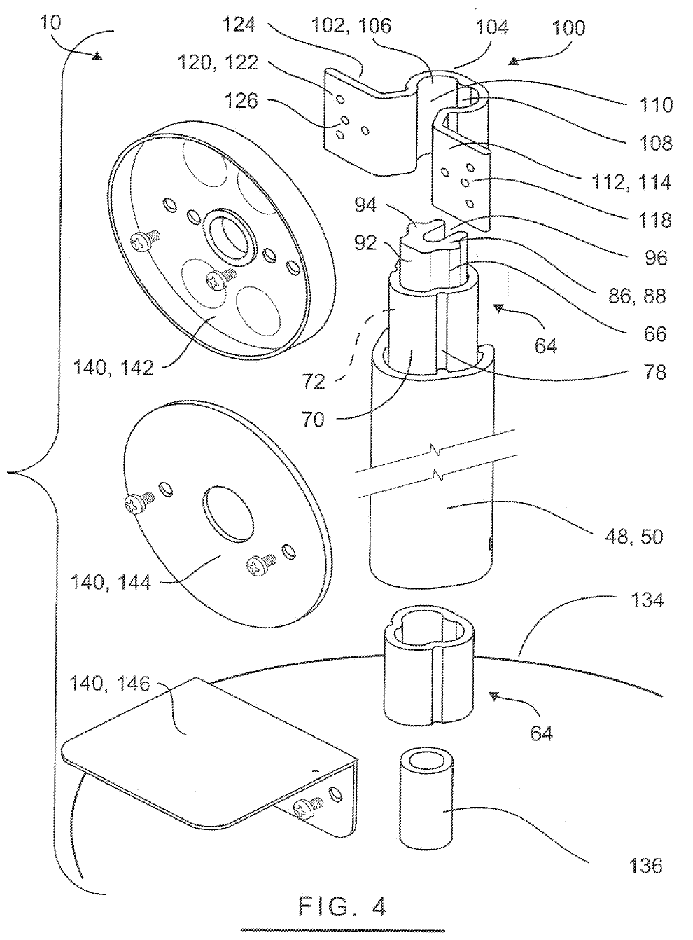

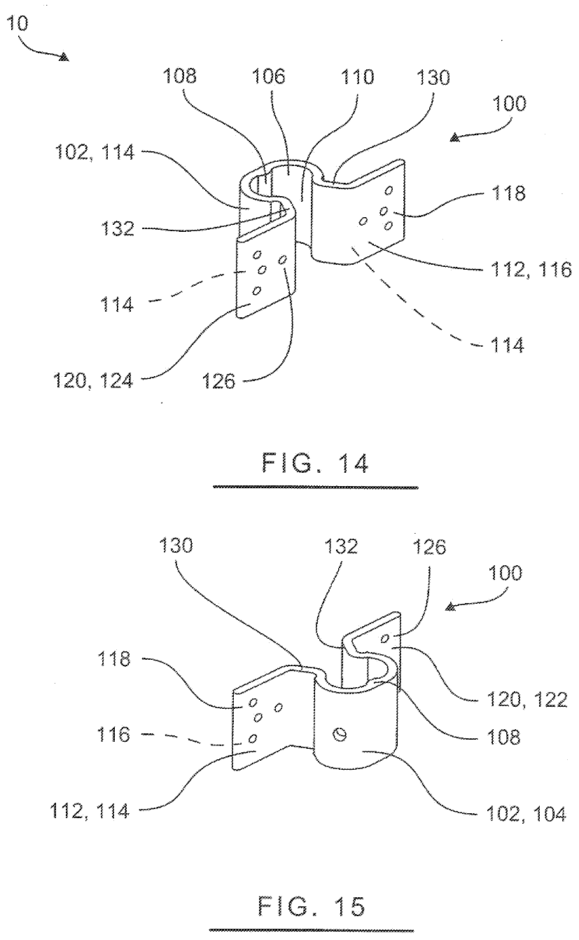

The device mounting bracket 100, as shown in FIGS. 14 and 15, is configured to fit on and around the hollow rod 64 and has a semi-circular section 102 that includes an outer surface 104, an inner surface 106, a guide rail 108, an opening 110, a first side member 112 with an outer surface 114 and an inner surface 116 having at least one device securing bore 118 therethrough, a second side member 120 with an outer surface 122 and an inner surface 124 having at least one device securing bore therethrough, a set screw 128, a first angled section 130, and a second angled section 132. Examples of devices that can be attached to or on the HASS in order to mount an item such as a smoke detector or camera include an electrical box, a metal bracket for magnetic items, or a shelf, all of which are shown in FIGS. 2 and 4.

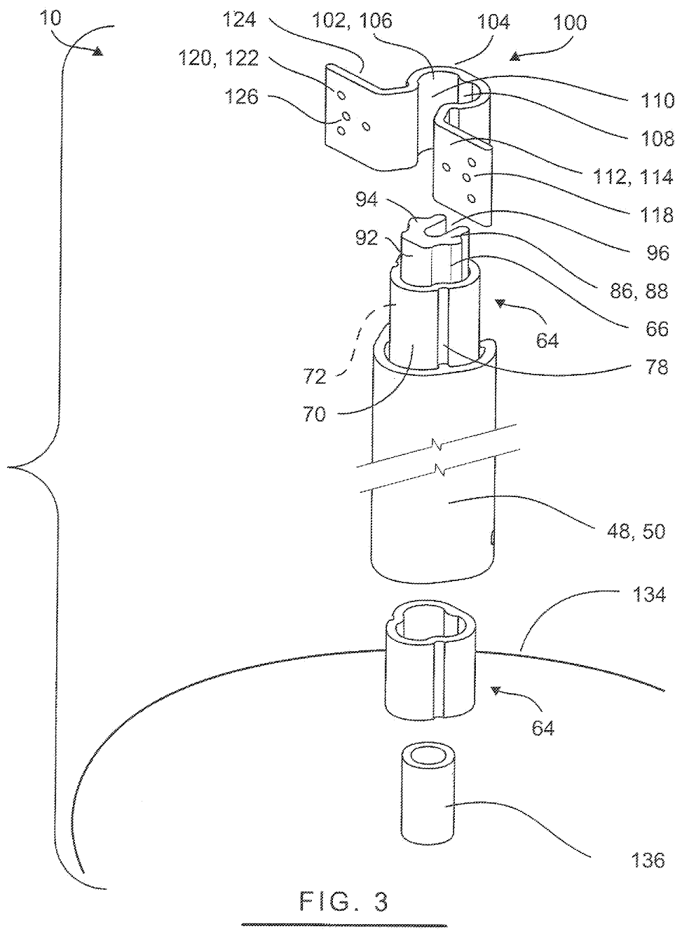

The second design configuration of the HASS 10, as shown in FIGS. 3, 4, 16, 19 and 20, is intended to be free-standing which allows the HASS 10 to be placed at many/various locations indoors and outdoors, and to be easily moved from one location to another.

The second design of the HASS 10 is structurally similar to the first design and includes a rod support member 48, a hollow rod that is configured to fit within the rod support member, a rod insert 86, a device mounting bracket 120, and a base 134. The difference between the first design and the second design, is that the second design does not have a rod mounting bracket 20 but does add a base 134 from which an insert 136 extends upward from the substantial center of the base 134, as shown in FIG. 4. The insert 136 is dimensioned to fit into and support the hollow rod in an upright, vertical position.

In order to add to or increase the functionality of the HASS 10, there can be at last two-one near the upper end and one near the lower end-combination pressure ball latch and cavity. The pressure ball latch is dimensioned to substantially fit within the cavity. By placing the cavity on the rod and the pressure ball latch on the bracket (or in the opposite configuration), a device mounted to the bracket can be locked in position at the upper or lower location. The device can be easily moved as only a small amount of force is required to dislodge the pressure ball latch from the cavity. While the two pressure ball latch and cavity combinations disclose one example of the use, it is important to note that any number of pressure ball latches and cavities, all of which can be equally spaced apart or arbitrarily placed, can be utilized. The actual number, and the placement of the pressure ball latches and cavities is up to the desire of the user, the requirement of use, and/or the decision on how to implement by the manufacturer of the HASS.

Also, when an item that has or uses a cable, such as a power cable or a data cable, is secured on the HASS, there is at least one slot that extends the longitudinal length of the rod. The slot is designed such that a cable will fit inside the slot while maintaining the cable within the slot and allowing access to the cable.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A height adjustable support structure (HASS) comprising:
a rod mounting bracket having:
a spacing member comprising:
an outer surface,
an inner surface.
a front surface.
a rear surface,
a first side surface
a second side surface
an upper perimeter edge,
a lower perimeter edge,
a depressed section located on the rear surface,
at least one bracket bore,
a rod support member that is integrally attached to the front surface of the spacing member, and having
an outer surface
an inner surface,
an open channel that functions as a wire slot,
an internal font rod guide,
an internal rear rod guide,
a bore,
a hollow rod that is configured to fit within the rod support member, and having:
an upper end,
a lower end,
an outer surface,
an inner surface,
semi-circular side sections
a rod slot,
a vertical channel,
at least one bore,
a rod insert that is configured to fit within the hollow rod and having:
an upper end,
a lower end,
an outer surface,
multiple semi-circular flanges,
a cable channel, and
a device mounting bracket that is configured to fit on and around the hollow rod, and having:
a semi-circular section having:
an outer surface,
an inner surface
a guide rail,
an opening,
a first side member with an outer surface and an inner surface having at least one device securing bore therethrough,
a second side member with an outer surface and an inner surface having at least one device securing bore therethrough,
a set screw,
a first angled section, and
a second angled section.

2. The height adjustable support structure of claim 1, wherein the HASS is configured to be fixedly attached to a surface.

3. The height adjustable support structure of claim 1, wherein the HASS is made of plastic.

4. The height adjustable support structure of claim 1, wherein the HASS is made of metal.

5. The height adjustable support structure of claim 1, wherein the HASS is made of a composite material.

6. The height adjustable support structure of claim 1, wherein the device mounting bracket is configured to allow various devices to be attached to the mounting bracket.

7. The height adjustable support structure of claim 1, wherein the rod mounting bracket further comprises a wrench holder to allow access and use of a wrench that tightens or loosens screws inserted into the bores on the HASS.

8. A height adjustable support structure comprising:
a rod support member having:
an outer surface,
an inner surface,
an open channel,
a wire slot,
an internal front rod guide,
an internal rear rod guide,
a bore,
a hollow rod that is configured to fit within the rod support member, and having:
an upper end,
a lower end,
an outer surface,
an inner surface,
semi-circular side sections,
a rod slot,
a vertical channel,
at least one bore,
a rod insert that is configured to fit within the hollow rod, and having:
an upper end,
a lower end,
an outer surface,
multiple semi-circular flanges,
a cable channel,
a device mounting bracket that is configured to fit on and around the hollow rod, and having:
a semi-circular section having:
an outer surface,
an inner surface,
an opening,
a first side member with an outer surface and an inner surface having at least one device securing bore therethrough,
a second side member with an outer surface, and an inner surface having at least one device securing bore therethrough,
a set screw,
a first angled section,
a second angled section, and
a base with an upper surface having a substantially centered upward extending insert that is configured to fit within the hollow rod at the hollow rod's lower end.

9. The height adjustable support structure of claim 8, wherein the HASS is configured to be free-standing with a secured device maintained at an upward position from the base.

10. The height adjustable support structure of claim 8, wherein the HASS is made of plastic.

11. The height adjustable support structure of claim 8, wherein the HASS is made of metal.

12. The height adjustable support structure of claim 8, wherein the HASS is made of a composite material.

13. The height adjustable support structure of claim 8, wherein the device mounting bracket is configured to allow various devices to be attached to the mounting bracket.

14. The height adjustable support structure of claim 8, wherein the rod member further comprises a wrench holder to allow access and use of a wrench that tightens or loosens screws inserted into the bores on the HASS.
